(19) United States
(12) Patent Application Publication
(10) Pub. No.: US 2006/0090961 A1
(43) Pub. Date: May 4, 2006

(54) Safety net system

(76) Inventor: John Rexroad, Kilingworth, CT (US)

Correspondence Address: ELLIS & VENABLE, PC, 101 NORTH FIRST AVE., SUITE 1875, PHOENIX, AZ, 85003, US

(21) Appl. No.: 10/979,425

(22) Filed: Nov. 2, 2004

(51) Int. Cl. A62B 1/22

(52) U.S. Cl. 182/138

(57) ABSTRACT

The invention is a safety net system that protects crew members working on high-rise buildings. The safety net system easily adjusts between floors of a high-rise building. The safety net system includes a net support assembly, a lifting mechanism, an anchoring mechanism, and a lower plate assembly. The lifting mechanism is coupled to the net support assembly. When the lifting mechanism is activated, the net support assembly is raised or lowered to the building floor where crew members are working. The anchoring mechanism and the lower plate assembly secure the net support assembly against the building when it is in place. Among other things, the safety net system allows crew members to work on high-rise buildings without the risk of being injured by a fall or dropped objects.

### FIELD OF THE INVENTION

The present invention relates generally to an apparatus used for maintaining a safe work environment, more particularly, to an apparatus that comprises a safety net system that maintains a safe work area for crews working on high-rise buildings both on the ground and in the air. Specifically, the present invention utilizes a lifting mechanism that allows a safety net system to easily be moved between the floors of a building undergoing maintenance or construction.

### BACKGROUND OF THE INVENTION

A crew maintaining or constructing a high-rise building must deal with many hazards in the work environment. Members of the crew on the ground and in the air must be constantly aware of their surroundings. Crew members on the ground must watch for dropped objects falling from above, and crew members working above ground must be conscious of where they are stepping to avoid a fall.

One way to protect the crew is to install a net that surrounds the perimeter of the building near where the crew members in the air are working. Each time the crew members working above ground change positions (i.e., move to a higher or lower distance above the ground), the net must be moved. This can become very time consuming and inconvenient causing delays in the progress of the work. Because of the time and effort involved, crew members may not adjust the height of the net as often as necessary to avoid the inconvenience.

The present invention provides crew members with an alternative to manually adjusting the safety net surrounding the building. The present invention includes a lifting mechanism that automatically adjusts the location or height of the safety net when activated. The lifting mechanism is secured to an upper floor of the building and comprises a lifting device and a lifting cable. The lifting cable is attached to the safety net system. When the lifting device is activated, the safety net assembly system is raised or lowered to the desired height so that the perimeter of the building is protected.

Once the safety net system is raised or lowered to the desired height, it is secured in place using an anchoring mechanism. The anchoring mechanism detachably connects to the building so that the safety net system is in a fixed position. The safety net system must be in a secured, fixed position when the lifting mechanism is not activated so that the crew members on the ground and in the air are protected from falling objects.

The cable extending from the lifting mechanism is secured to a lower plate assembly. The lower plate assembly is detachably connected to a floor that is in a lower position than the safety net assembly. The cable must be braced in a rigid position because the safety net assembly moves along the cable. Additionally, the cable is used to help secure the safety net system in place when it is not changing positions.

Currently, there are devices that use safety nets attached to buildings to protect people working on maintenance or construction crews. However, each of these devices suffers from several disadvantages. First, the devices are difficult to move between floors and secure into position. They require a multi step process that involves many parts, and the installation process makes it difficult to change the position of the safety net assembly. Moving the prior art safety net systems each time the crew moves one floor higher or lower is difficult and requires a great deal of time and energy. The prior art devices are complicated and require a time consuming and inconvenient process.

Second, the prior art devices do not automatically raise and lower the safety net assembly. The prior art devices require the safety net assembly to be manually raised or lowered when changing positions creating an increased risk for the crew members. This is a limitation of the prior art that the present invention overcomes.

Presently, there is no safety net system that is easy to automatically adjust and secure between floors of a building or can move between more than one building floor at a time. For the foregoing reasons, a device that would allow maintenance or construction crews to easily adjust and secure a safety net system is desired.

### SUMMARY OF THE INVENTION

It is an object of the present invention to provide a safety net system that is automatically raised and lowered by a lifting mechanism.

It is a further object of the present invention to provide a safety net system that is easily secured when stationary.

It is a further object of the present invention to provide a safety net system that can be folded up against the building for cleaning or in inclement weather conditions.

It is a further object of the present invention to provide a safety net system that can be easily and quickly moved to provide the optimal protection for the crew members.

It is a further object of the present invention to provide a safety net system where a lifting device is activated to automatically raise or lower the safety net.

It is a further object of the present invention to provide a safety net system that quickly and easily secures to the building.

It is a further object of the present invention to provide a safety net system that can move between more than one building floor at a time and only requires a higher and lower attachment point.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C §112, paragraph 6 to define the invention. To the contrary, if the provisions of 35 U.S.C §112, paragraph 6 are sought to be invoked to define the invention(s), the claims will specifically state the phrases “means for” or “step for” and a function, without also reciting in such phrases any structure, material, or act in support of the function.

Moreover, even if the provisions of 35 U.S.C §112, paragraph 6 are invoked to define the inventions, it is intended that the inventions not be limited only to the specific structure, material or acts that are described in the preferred embodiments, but in addition, include any and all structures, materials or acts that perform the claimed function, along with any and all known or later developed equivalent structures, materials, or acts for performing the claimed function.

### BRIEF DESCRIPTION OF THE DRAWINGS

FIG. 1 shows a top view of the safety net system.

FIG. 2 shows a perspective view of the sliding arm of the net support assembly.

FIG. 3 shows a cut away view of the sliding arm.

FIG. 4 shows a perspective view of the lifting mechanism.

FIG. 5 shows a perspective view of the lifting mechanism with the net flap folded for lifting.

FIG. 6 shows a perspective view of the lifting mechanism with the lifting handle in the “up” position.

FIG. 7 shows a perspective view of the lifting mechanism with the lifting handle in the “down” position.

FIG. 8 shows a perspective view of the lifting mechanism with the net support assembly in the lifted position.

FIG. 9 shows a top view of the sliding arm with two foldable arms on the corner of a building.

FIG. 10 shows a side view of a second embodiment of the sliding arm with foldable arms.

FIG. 11 shows a perspective view of the sliding arm in a folded position.

FIG. 12 shows a perspective view of the lower plate assembly.

FIG. 13 shows a perspective view of the safety net system secured between floors.

FIG. 14 shows a perspective view of the safety net system being lifted.

FIG. 15 shows a perspective view of the safety net system being lifted from the top.

FIG. 16 shows a perspective view of the safety net system being lifted from below.

FIG. 17 shows a perspective view of the safety net system with the lifting cable attached at the bottom.

### DESCRIPTION OF PREFERRED EMBODIMENTS

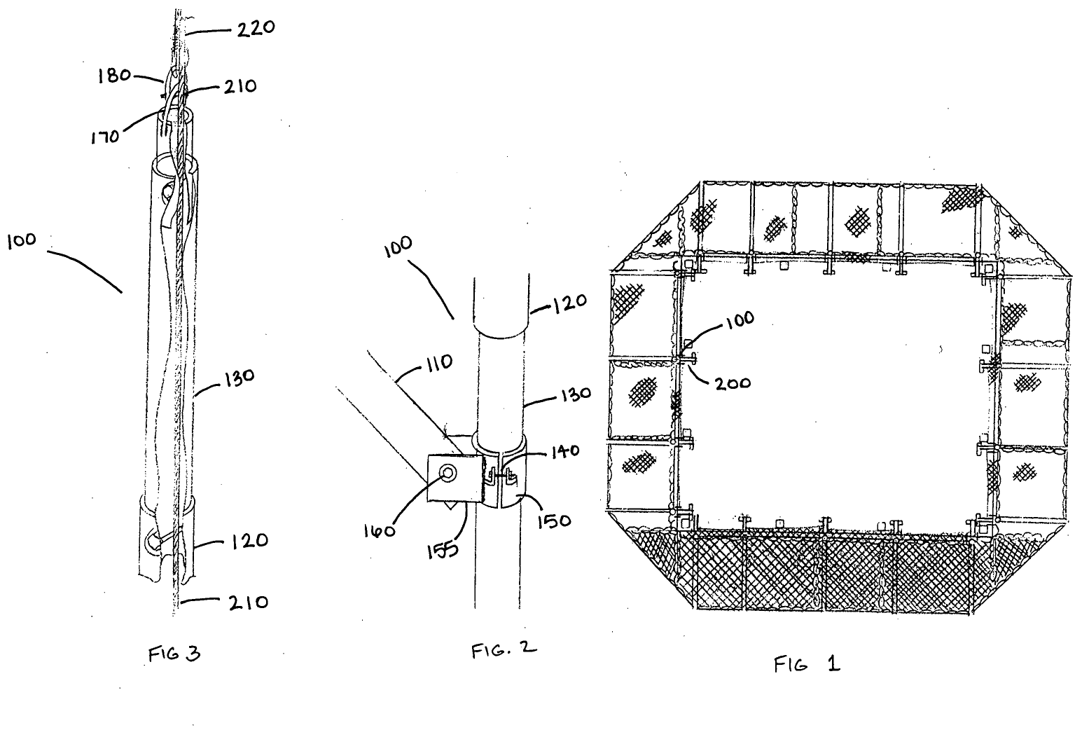

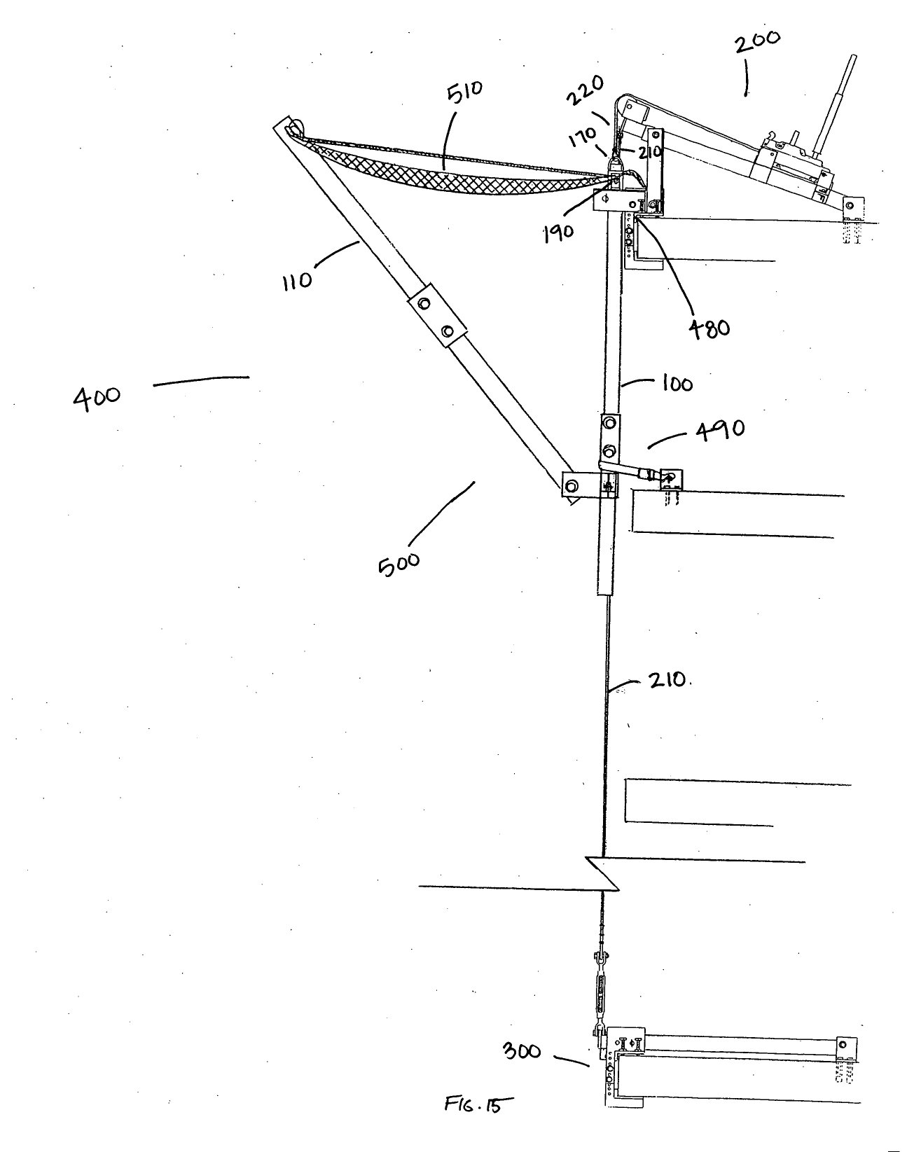

As shown in FIG. 13, the preferred embodiment of the safety net system 400 generally includes a lifting mechanism 200, a net support assembly 500, an anchoring mechanism 450, and a lower plate assembly 300. These components work together to automatically raise and lower a safety net system 400 attached around the perimeter of a building as shown in FIG. 1.

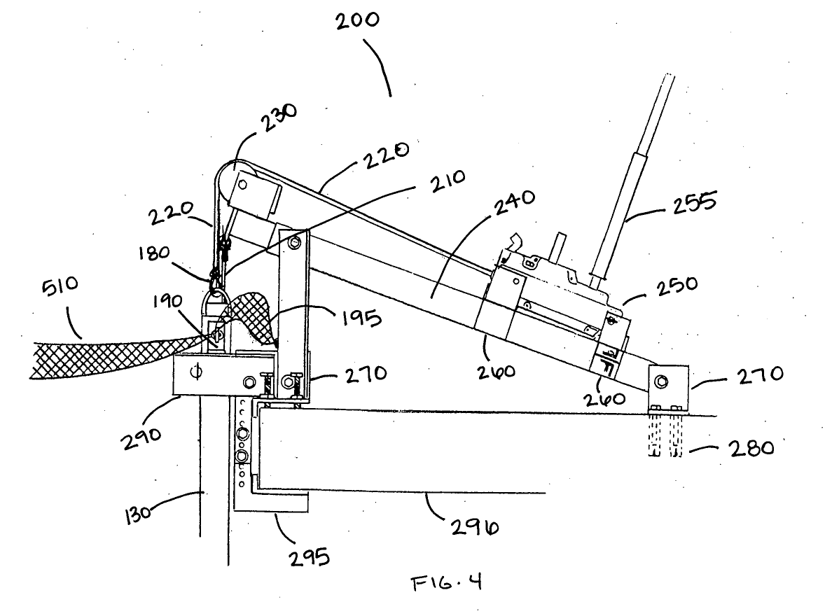

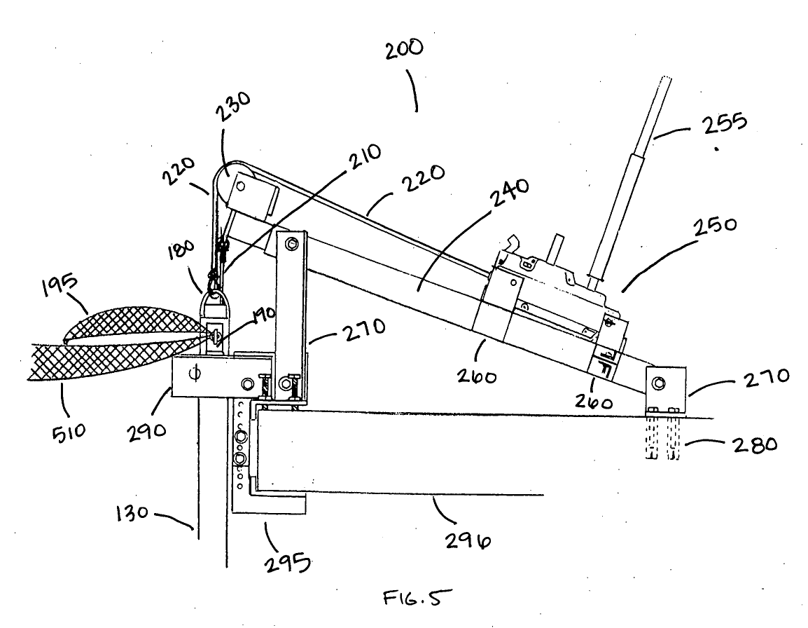

As shown in FIGS. 2 and 3, the sliding arm 100 of the net support assembly 500 consists of two sections for easy shipping. In an alternate embodiment, the sliding arm 100 consists of one section. FIG. 3 shows the section of the sliding arm 100 that is attached to the lifting mechanism 200 and the safety net 510. This section of the sliding arm 100 includes a coupler 120, a vertical support 130, and a lifting loop 170. The vertical support 130 is the component of the sliding arm 100 that may move up and down the slide cable 210. The slide cable 210 runs through the vertical support 130 and keeps the net support assembly 500 stabilized while being raised and lowered. The slide cable 210 also helps to secure the net support assembly 500 to the building when it is in a stationary position.

Also attached to this section of the sliding arm 100 is the lifting loop 170 that attaches the sliding arm 100 to the lifting mechanism 200. The lifting cable 220 extends from the lifting mechanism 200 and attaches to the lifting loop 170 with a hook or shackle 180. The lifting cable 220 raises or lowers the entire net support assembly 500 when the lifting mechanism 200 is activated. This section of the sliding arm 100 also includes an angle clip 190 as shown in FIG. 13 just below the lifting loop 170 that connects to the safety net 510.

FIG. 2 shows the section of the sliding arm 100 connected to a cantilever arm 110. An arm clip 150 with an attached mounting plate 155 is secured to the sliding arm 100 by a clamp 140. On one end, the cantilever arm 110 is coupled to the mounting plate 155 with a pin 160, and on the other end the cantilever arm 110 is coupled to the safety net 510 as shown in FIG. 13. The pin 160 attachment enables the cantilever arm 110 to be folded parallel to the sliding arm 100 as seen in FIG. 11. This embodiment is preferred to enable storage when not in use as well as easy maintenance and cleaning and to protect the safety net system 400 from inclement weather.

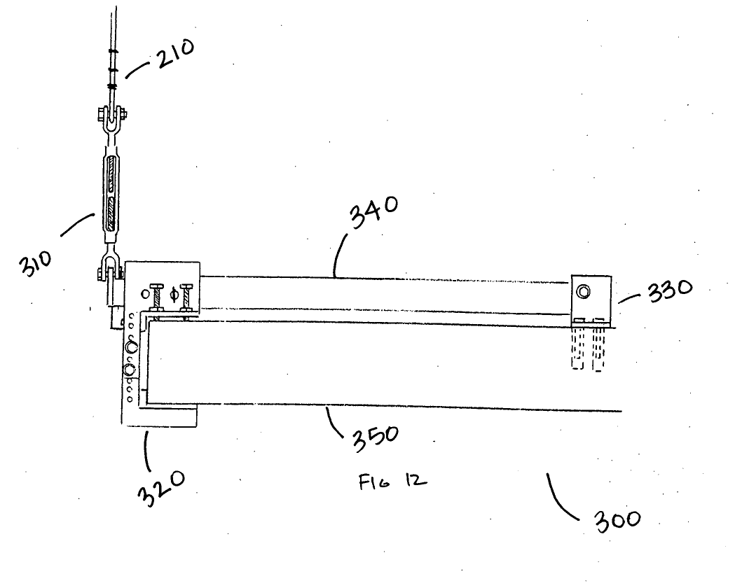

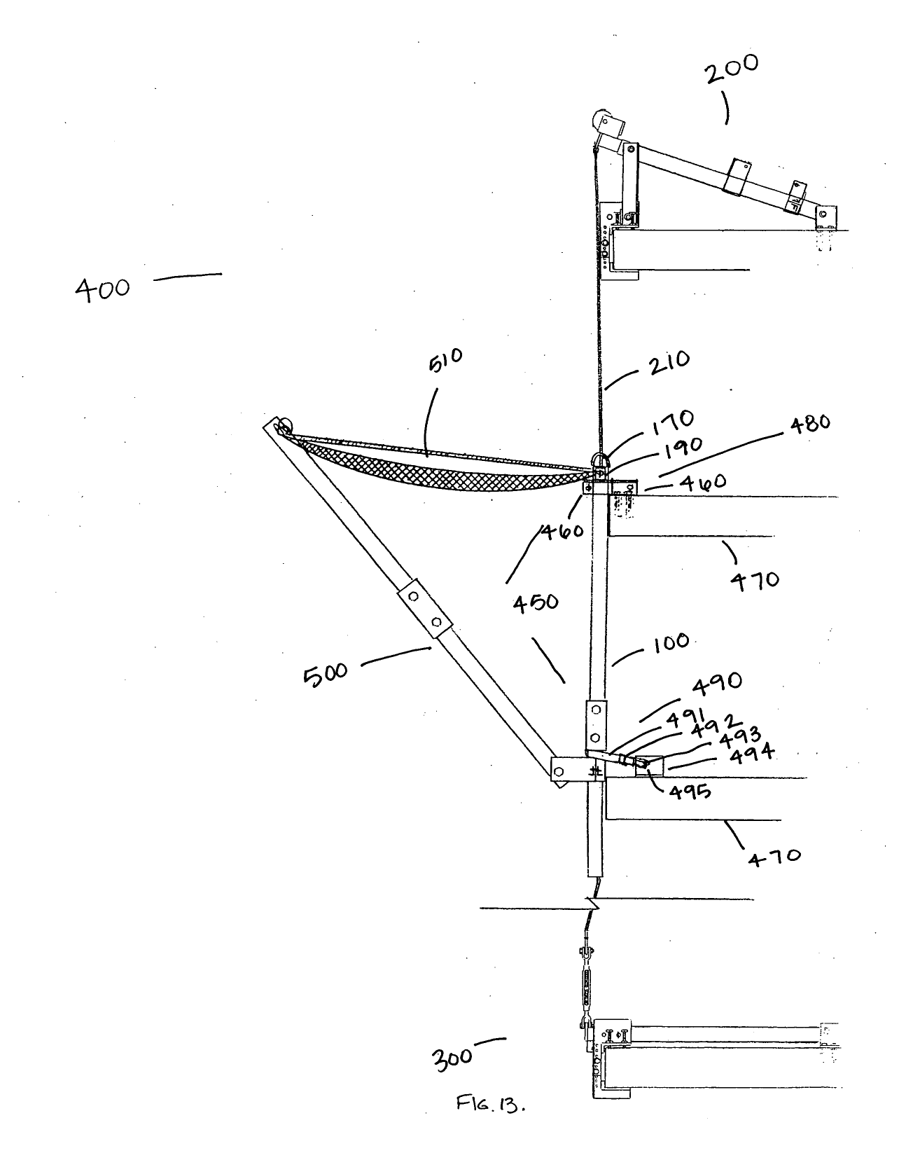

As illustrated by FIG. 9, an alternate embodiment of the sliding arm 100 and cantilever arm 110 attachment allows two cantilever arms 110 to be attached to a single sliding arm 100. This embodiment is preferred when a safety net system 400 is anchored at the corner of a building. Rather than having a separate safety net system 400 on each side of the corner, one safety net system 400 protects both sides of the corner by having two net support assemblies 500 with one sliding arm 100. Using one safety net system 400 with two cantilever arms 110 around a corner as opposed to two safety net systems 400 increases efficiency and reduces cost.

As shown in FIG. 13, when the net support assembly 500 is in the lowered position, the anchoring mechanism 450 is installed to lock the net support assembly 500 in place and provide the necessary security to ensure that the net support assembly 500 stays in a rigid position. The anchoring mechanism 450 is a combination of two mechanisms located separately along the sliding arm 100. The first mechanism 480 is located directly below the angle clip 190 that attaches the sliding arm 100 to the safety net 510. The first mechanism 480 comprises a mounting plate 460 that is attached to the sliding arm 100. The mounting plate 460 is preferably bolted into the building floor 470 or in an alternate embodiment, attached to a steel beam, at or below where crew members are working.

The second mechanism 490 comprises a web 491, a ratchet 492, a hook 493, a mounting plate 494, and an eyebolt 495. The mounting plate 494 of the second mechanism 490 is preferably attached to the beam 470 of the building floor that is directly below the first mechanism 480. The web 491 loops around the sliding arm 100 and attaches to the mounting plate 494 with a hook 493 and an eyebolt 495. A ratchet 492 is affixed to the web 491 so that the sliding arm 100 can be tightened against the side of the building. Both anchoring mechanisms 450 are detachable from the sliding arm 100 and the beam 470 of the building floor so that the net support assembly 500 can move along the slide cable 210.

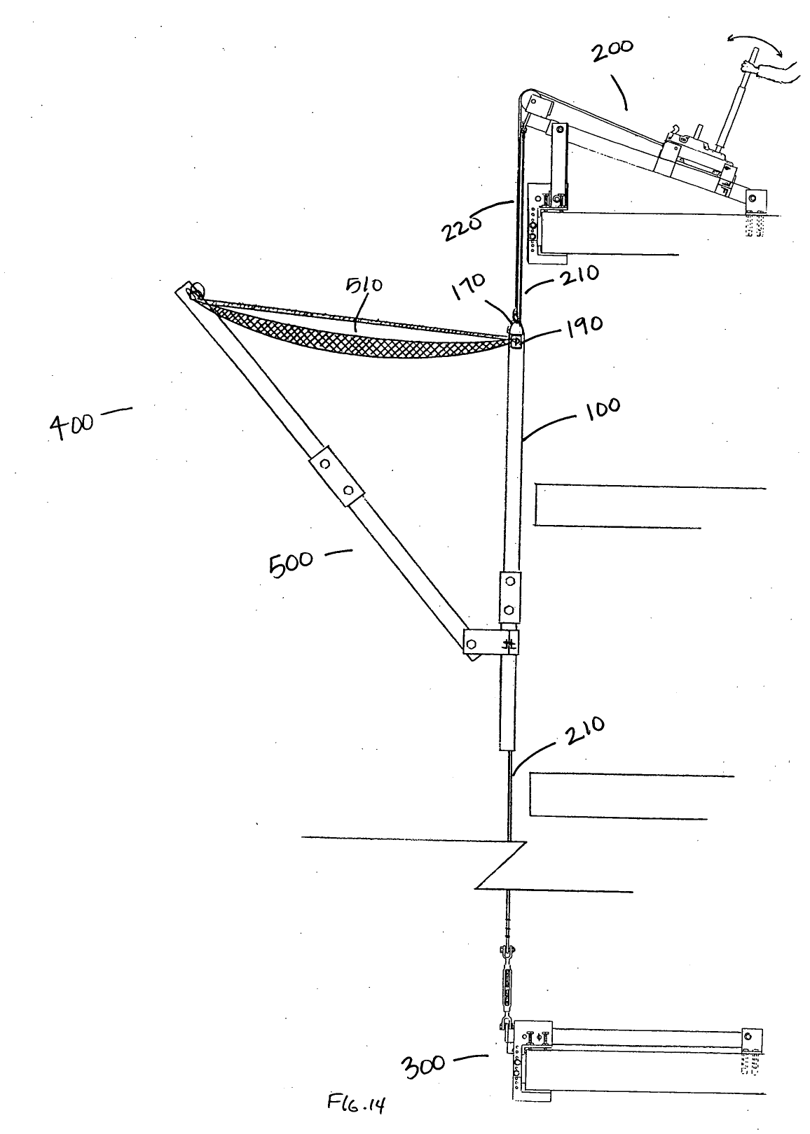

As depicted in FIG. 12, a lower plate assembly 300 secures the end of the slide cable 210 opposite the lifting mechanism 200 to the building. The lower plate assembly 300 includes a beam clamp 320, a mounting plate 330, a support bar 340, and a turnbuckle 310. The beam clamp 320 is coupled to a beam 350 of a building floor that is lower than the second mechanism 490 of the anchoring mechanism 450. The support bar 340 runs parallel to the beam 350 of the building floor. One end of the support bar 340 attaches to the beam clamp 320 and the other end attaches to the mounting plate 330. The support bar 340 provides the strength required to keep the lower plate assembly 300 firmly in place. The lower plate assembly 300 must be tightly in place so that the slide cable 210 and the net support assembly 500 remain rigid. The turnbuckle 310 attaches to the beam clamp 320 and the slide cable 210. A turnbuckle 310 is preferred to secure the slide cable 210 to the lower plate assembly 300 because a turnbuckle 310 provides a way to maintain tautness in the slide cable 210 without detaching it from the lifting mechanism 200.

FIG. 14 illustrates the lifting mechanism 200 moving the net support assembly 400 along the slide cable 210. The lifting mechanism 200 consists of a lifting device 250, a lifting arm 240, a slide cable 210, a lifting cable 220, a pulley wheel 230, a lifting handle 255, a clamp bracket 260, mounting plates 270, and a beam clamp 295 as shown in FIG. 4. The lifting device 250 is fastened to the lifting arm 240 using two clamp brackets 260, and the lifting arm 240 is coupled between two mounting plates 270. One mounting plate 270 directly attaches to the beam 296 of a building floor, and the other mounting plate 270 attaches to the beam clamp 295. The beam clamp 295 connects to the beam 296 of a building floor and maintains the lifting arm 240 in a fixed position. Extending from the lifting device 250 is the lifting cable 220. The lifting cable 220 stretches across the pulley wheel 230 and hooks to the sliding arm 100. The slide cable 210 attaches to the lifting arm 240 and extends down through the sliding arm 100 to the turnbuckle 310 of the lower plate assembly 300.

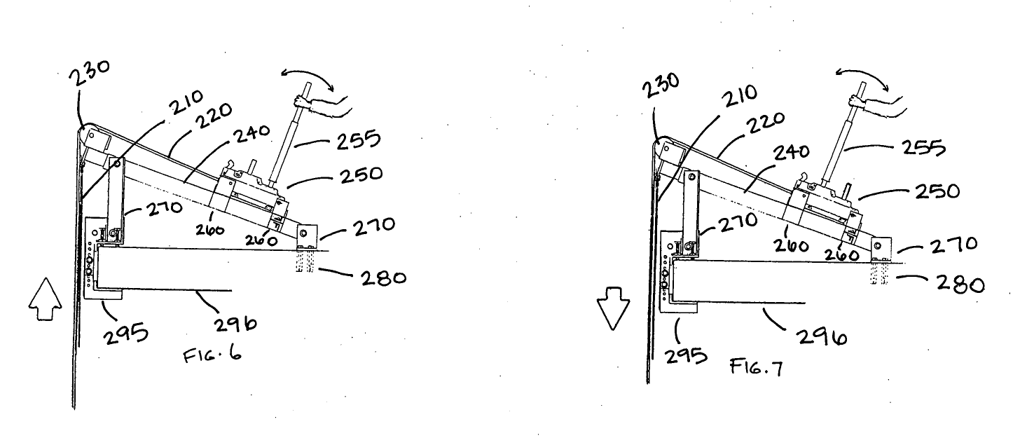

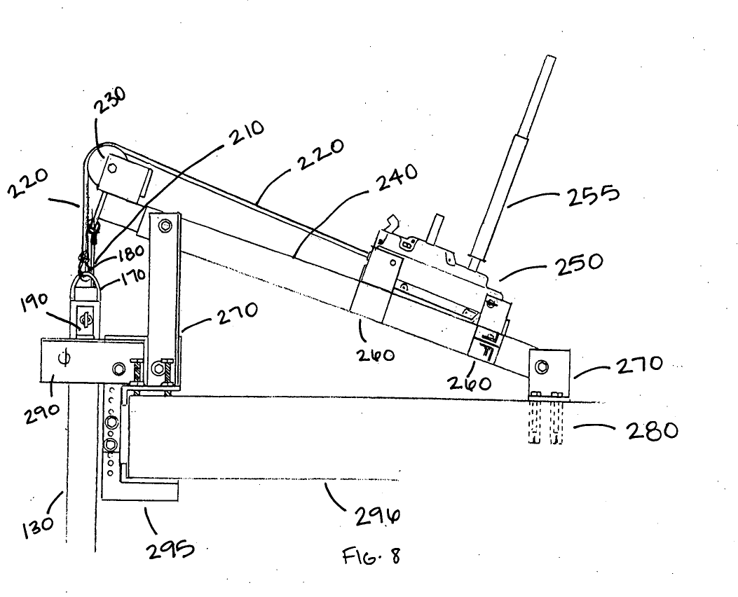

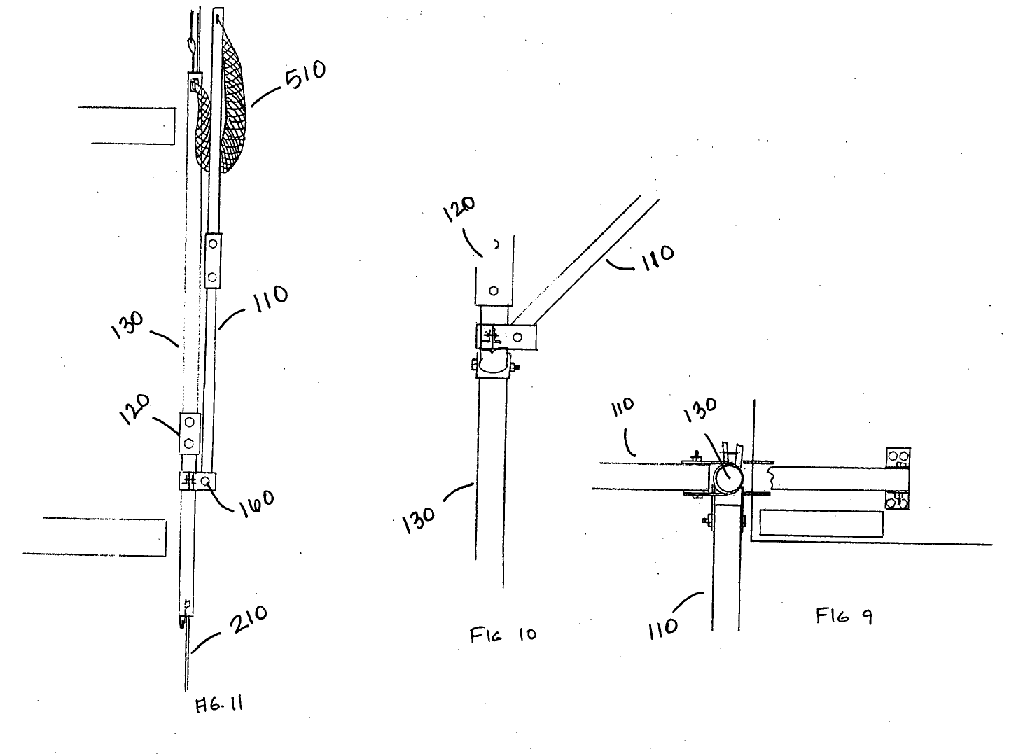

When the lifting handle 255 activates the lifting device 250, the lifting cable 220 moves across the pulley wheel 230 and raises or lowers the net support assembly 500. FIG. 6 shows the lifting handle 255 in position to raise the net support assembly 500, and FIG. 7 shows the lifting handle 255 in position to lower the net support assembly 500. Additionally, when the net support assembly 500 is being raised or lowered, the net flap 195 closest to the building should be folded back to allow the sliding arm 100 to move as shown in FIG. 5. Alternate embodiments of the lifting device 250 can be used to raise and lower the safety net system 400. Examples of alternate embodiments include a come-along, a chain fall, pulling from an eyebolt the building floor above, or pulling off of a column.

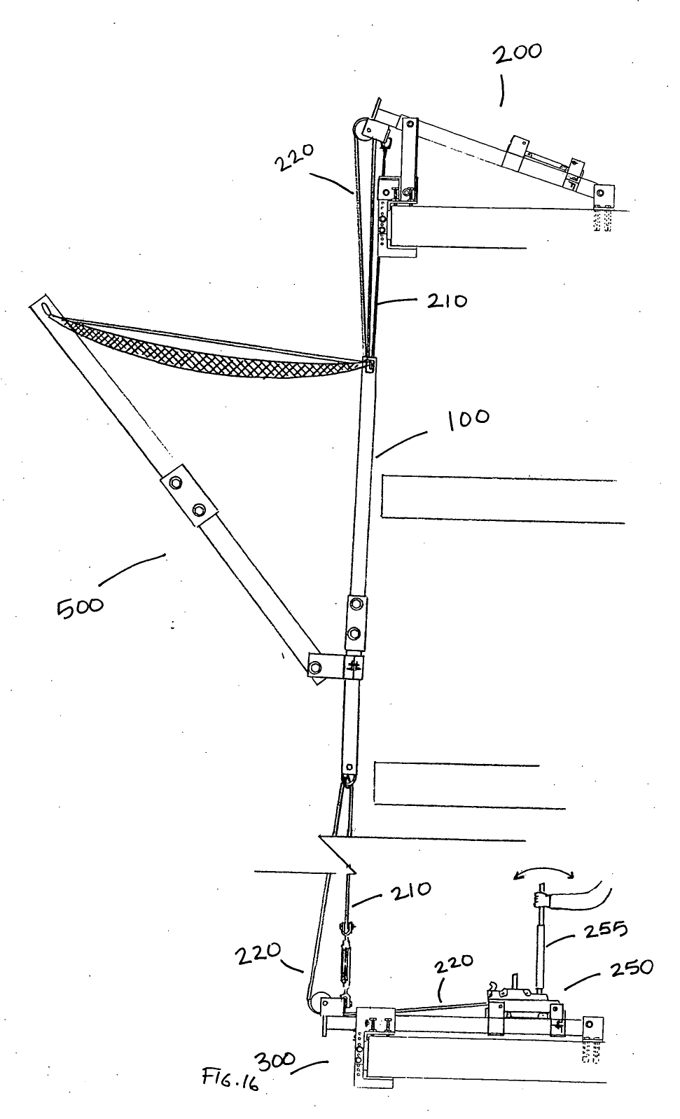

FIG. 15 shows how the entire safety net system 400 can be moved to accommodate buildings of different heights. The lifting mechanism 200 is detached and re-installed at a higher building floor. The lower plate assembly 300 is also detached and re-installed at a higher building floor. Once the lifting mechanism 200 and lower plate assembly 300 are re-installed, the safety net system 400 will operate as described above.

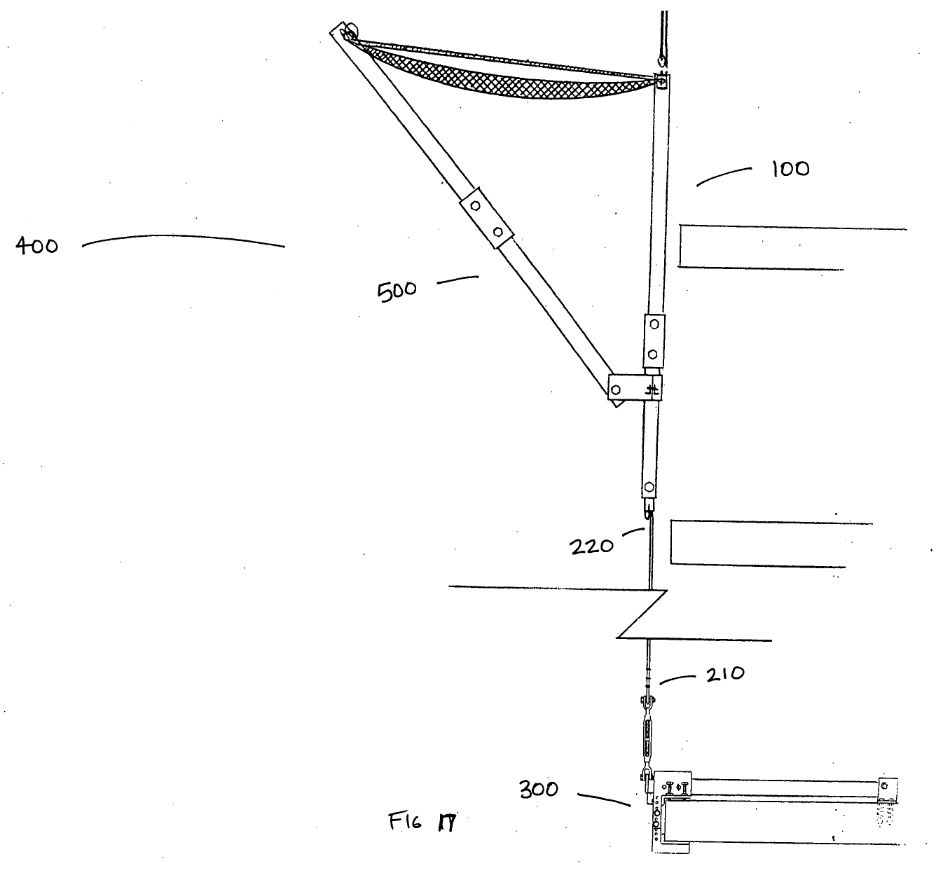

Alternate embodiments of the invention are depicted in FIGS. 16 and 17. In FIG. 16, the lifting device 250 is attached to the lower plate assembly 300, and the net support assembly 500 is lifted from below. In this embodiment, the lifting loop 170 is located on the section of the sliding arm 100 where the cantilever arm 110 attaches. Also, the lower plate assembly 300 and the lifting mechanism 200 include a pulley wheel 230 to guide the lifting cable 220. Additionally, in this embodiment, the lifting cable 220, as well as the slide cable 210, goes through the vertical support 130 of the sliding arm 100.

FIG. 17 shows an embodiment with the lifting cable 220 attached to the bottom of the sliding arm 100. The lifting cable 220 runs through the vertical support 130 of the sliding arm 100 in this embodiment.

The preferred embodiment of the invention is described above, in the Drawings, and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A safety net system comprising:
A. a lifting mechanism,
B. a net support assembly,
C. a lower plate assembly,
D. a slide cable,
E. a lifting cable,
F. said lifting mechanism further comprising:
1. a support beam, and
2. a winch,
G. said net support assembly further comprising:
1. a net with a first end and a second end,
2. a cantilever beam with a first end and a second end, and
3. a sliding arm with a top and a bottom,
H. said lower plate assembly further comprising:
1. a clamp, and
2. a turnbuckle,
I. said slide cable further comprising:
1. a first end, and
2. a second end,
J. said lifting cable further comprising:
1. a first end, and
2. a second end,
K. said first end of said cantilever beam is coupled to said bottom of said sliding arm,
L. said second end of said cantilever beam is coupled to said first end of said net,
M. said top of said sliding arm is coupled to said second end of said net,
N. said turnbuckle is coupled to said clamp of said lower plate assembly,
O. said first end of said slide cable is coupled to said support beam of said lifting mechanism, and said second end of said slide cable is coupled to said turnbuckle of said lower plate assembly such that said slide cable passes through said sliding arm, and
P. said first end of said lifting cable is coupled to said top of said sliding arm, and said second end of said lifting cable is coupled to said winch of said lifting mechanism such that said lifting cable adjusts so that said net support assembly may vary from a low position to a high position when said winch is activated.

2. The safety net system of claim 1 wherein:
A. said first end of said slide arm further comprises a lifting loop such that said lifting cable is coupled to said lifting loop.

3. The safety net system of claim 1 wherein:
A. said lifting mechanism is secured to a first beam, said first beam being secured to a first building floor.

4. The safety net system of claim 3 wherein:
A. said lower plate assembly is secured to a second beam, said second beam being secured to a second building floor some distance below said first beam.

5. The safety net system of claim 4 wherein:
A. said net support assembly is secured to a third beam, said third beam being secured to a third building floor and a fourth beam, said fourth beam being secured to a fourth building floor between said first beam and said second beam such that said net support assembly remains rigid.

6. The safety net system of claim 1 wherein:
A. said first end of said cantilever beam is secured to said bottom of said sling arm with a pin bolt such that said cantilever beam is retractable.

7. The safety net system of claim 1 wherein:
A. said lifting mechanism further comprises a pulley wheel such that said lifting cable rotates around said pulley wheel when said winch is activated and adjusts height of said net support assembly.

8. The safety net system of claim 1 wherein:
A. said turnbuckle is tightened to keep said slide cable taut.

9. The safety net system of claim 1 wherein:
A. said lower plate assembly further comprises a reinforcement beam such that said reinforcement beam secures said lower plate assembly to said second beam with a mounting plate.

10. A method of adjusting a safety net system comprising the steps of:
A. coupling a net support assembly to a lifting mechanism, said net support assembly further comprising a cantilever beam, a sliding arm, and a net,
B. coupling a lower plate assembly to said lifting mechanism, said lower plate assembly further comprising a turnbuckle and a clamp,
C. coupling a first end of said cantilever beam to a bottom of said sliding arm,
D. coupling a second end of said cantilever beam to a first end of said net,
E. coupling a second end of said net to a top of said sliding arm,
F. coupling a first end of a slide cable to said lifting mechanism, said lifting mechanism further comprising a support beam and a lifting cable,
G. coupling a second end of said slide cable to said turnbuckle such that said slide cable passes through said sliding arm, and
H. coupling a first end of said lifting cable to said top of said sliding arm, and coupling a second end of said lifting cable to a winch such that said lifting cable adjusts so that said net support assembly may vary from a low position to a high position when said winch is activated.

11. The method of claim 10 further comprising the step of:
A. coupling said lifting cable to said top of said sliding arm, said sliding arm further comprising a lifting loop such that said lifting loop is coupled to said lifting cable.

12. The method of claim 10 further comprising the step of:
A. securing said lifting mechanism to a first beam, said first beam being secured to a first building floor.

13. The method of claim 12 further comprising the step of:
A. securing said lower plate assembly to a second beam, said second beam being secured to a second building floor some distance below said first beam.

14. The method of claim 13 further comprising the step of:
A. securing said net support assembly to a third beam, said third beam being secured to a third building floor and to a fourth beam, said fourth beam being secured to a fourth building floor between said first beam and said second beam such that said net support assembly remains rigid.

15. The method of claim 10 further comprising the step of:
A. securing said first end of said cantilever beam to said bottom of said sliding arm with a pin bolt such that said cantilever beam is retractable.

16. The method of claim 10 further comprising the step of:
A. coupling said lifting cable to said lifting mechanism, said lifting mechanism further comprising a pulley wheel such that said lifting cable rotates around said pulley wheel when said winch is activated.

17. The method of claim 10 further comprising the step of:
A. tightening said turnbuckle to keep said slide cable taut.

18. The method of claim 10 further comprising the step of:
A. securing said lower plate assembly to said second beam, said lower plate assembly further comprising a reinforcement beam such that said lower plate assembly is secured to said second beam with a mounting plate.
